(19) United States
(12) Patent Application Publication
(10) Pub. No.: US 2020/0082973 A1
(43) Pub. Date: Mar. 12, 2020

(54) HIGHLY DEFORMABLE AND THERMALLY TREATABLE CONTINUOUS COILS AND METHOD OF PRODUCING THE SAME

(71) Applicant: NOVELIS INC., Atlanta, GA (US)

(72) Inventors: RAHUL VILAS KULKARNI, MARIETTA, GA (US); CEDRIC WU, MARIETTA, GA (US); TODD SUMME, MARIETTA, GA (US); EMANUEL BECK, APROZ (CH); MICHELE EDITH BERNER, SION (CH); KURT SEKINGER, VOLKETSWIL (CH); DAVID LEYVRAZ, SIERRE (CH); THERESA ELIZABETH MACFARLANE, WOODSTOCK, GA (US)

(73) Assignee: NOVELIS INC., ATLANTA, GA (US)

(21) Appl. No.: 16/566,288

(22) Filed: Sep. 10, 2019

Related U.S. Application Data
(60) Provisional application No. 62/729,702, filed on Sep. 11, 2018.
(60) Provisional application No. 62/729,741, filed on Sep. 11, 2018.

(51) Int. Cl. H01F 27/28; C25D 11/08; C25D 11/16; H01F 41/04

(52) U.S. Cl. CPC H01F 27/2847; H01F 41/04; C25D 11/16; C25D 11/08

(57) ABSTRACT

Described herein are anodized continuous coils containing a thin anodized film layer and methods for making and using the same. The anodized continuous coils include an aluminum alloy continuous coil, wherein a surface of the aluminum alloy continuous coil comprises a thin anodized film layer. The anodized continuous coils maintain the anodized film layer during deforming processes.

### CROSS-REFERENCE TO RELATED APPLICATIONS

The present application claims priority to and filing benefit of U.S. Provisional Patent Application No. 62/729,741, filed on Sep. 11, 2018, and U.S. Provisional Patent Application No. 62/729,702, filed on Sep. 11, 2018, both of which are incorporated herein by reference in their entireties.

### FIELD

The present disclosure relates to metal working generally and more specifically to anodized continuous coils.

### BACKGROUND

Certain metal products, such as aluminum alloys, can require a deforming step to create a metal product. These metal products can also require a coating step for reasons including safety, aesthetics, and information. Pretreatments are sometimes applied on the surfaces of metal products to enhance the adhesion properties of the metal sheets. However, these pretreatment layers are often damaged during deforming and/or downstream thermal processing.

### SUMMARY

Covered embodiments of the invention are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

Described herein are anodized continuous coils and methods for making and using the same. An anodized continuous coil as described herein includes an aluminum alloy continuous coil, where a surface of the aluminum alloy continuous coil comprises a thin anodized film layer. The thin anodized film layer includes a barrier layer that can be up to about 25 nm thick. The thin anodized film layer can also include a filament layer that can be up to about 250 nm thick. Optionally, the thin anodized film layer, including the barrier layer and optional filament layer, can be less than about 5 μm thick. The aluminum alloy continuous coil can comprise a 7xxx series aluminum alloy.

Also described herein are aluminum alloy products including the anodized continuous coils as described herein. The aluminum alloy products can be automobile body parts, among others.

Further described herein are methods of making an anodized continuous coil. The methods of making an anodized continuous coil include providing an aluminum alloy continuous coil, wherein the aluminum alloy continuous coil is processed in a metal processing line having a preselected line speed; preparing a surface of an aluminum alloy continuous coil and anodizing the surface of the aluminum alloy continuous coil in an electrolyte to form a thin anodized film layer, wherein anodizing parameters are tailored to the line speed of the metal processing line. The thin anodized film layer can be an aluminum oxide layer. The thin anodized film layer prepared according to the methods described herein can be less than about 5 μm thick. The electrolyte can include one or more of sulfuric acid, nitric acid, and phosphoric acid. The preparing step can include one or both of etching the surface of the aluminum alloy continuous coil with an acidic solution and electrolytically cleaning the surface of the aluminum alloy continuous coil.

The methods of making an anodized continuous coil can further include a step of cleaning the surface of the aluminum alloy continuous coil prior to the preparing step and/or a step of rinsing the thin anodized film layer after the anodizing step. The methods can further comprise drying the surface of the aluminum alloy continuous coil. Optionally, the aluminum alloy continuous coil includes a 7xxx series aluminum alloy. The acidic solution in the etching step can include one or more of sulfuric acid, nitric acid, and phosphoric acid, or any other acidic solution.

Other objects, aspects, and advantages will become apparent upon consideration of the following detailed description of non-limiting examples.

### DETAILED DESCRIPTION

Described herein are continuous coils having a thin anodized film-containing surface and methods of making and using the continuous coils. The resulting continuous coils can be used, for example, to produce anodized aluminum alloy products that have superior surface qualities and minimized surface defects as compared to aluminum alloy products prepared from coils without a thin anodized film-containing surface as described herein. The continuous coils as described herein have a particularly robust and durable surface when exposed, for example, to downstream deforming procedures (e.g., elongation, forming, bending, artificial aging, solution heat treatment, hot forming, warm forming, annealing, paint baking, or the like). In addition, continuous coils prepared according to the methods described herein exhibit exceptional adhesion promotion and corrosion resistance.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by aluminum industry designations, such as “series” or “AA7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

Aluminum alloys are described herein in terms of their elemental composition in weight percentage (wt. %) based on the total weight of the alloy. In certain examples of each alloy, the remainder is aluminum, with a maximum wt. % of 0.15% for the sum of the impurities.

Reference is made in this application to alloy condition or temper. For an understanding of the alloy temper descriptions most commonly used, see “American National Standards (ANSI) H35 on Alloy and Temper Designation Systems.” An F condition or temper refers to an aluminum alloy as fabricated. An 0 condition or temper refers to an aluminum alloy after annealing. An Hxx condition or temper, also referred to herein as an H temper, refers to a non-heat treatable aluminum alloy after cold rolling with or without thermal treatment (e.g., annealing). Suitable H tempers include HX1, HX2, HX3 HX4, HX5, HX6, HX7, HX8, or HX9 tempers. A T1 condition or temper refers to an aluminum alloy cooled from hot working and naturally aged (e.g., at room temperature). A T2 condition or temper refers to an aluminum alloy cooled from hot working, cold worked, and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a twin block caster, or any other continuous caster), electromagnetic casting, hot top casting, or any other casting method.

As used herein, a “continuous coil” or an “aluminum alloy continuous coil” refers to an aluminum alloy subjected to a continuous processing method on a continuous line without breaks in time or sequence (i.e., the aluminum alloy is not subjected to batch processing).

As used herein, the meaning of “a,” “an,” or “the” includes singular and plural references unless the context clearly dictates otherwise.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C.

All ranges disclosed herein are to be understood to encompass any and all endpoints and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

### Anodized Continuous Coils

Described herein are continuous coils having a thin anodized film-containing surface, which are referred to herein as anodized continuous coils. The surface of the continuous coils includes a thin anodized film layer, which includes a barrier layer and optionally a filament layer. The thin anodized films (TAFs) can be applied to a continuous coil of any suitable aluminum alloy. The aluminum alloy can include a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy.

Optionally, the aluminum alloy as described herein can be a 1xxx series aluminum alloy according to one of the following aluminum alloy designations: AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Optionally, the aluminum alloy as described herein can be a 2xxx series aluminum alloy according to one of the following aluminum alloy designations: AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Optionally, the aluminum alloy as described herein can be a 3xxx series aluminum alloy according to one of the following aluminum alloy designations: AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Optionally, the aluminum alloy as described herein can be a 4xxx series aluminum alloy according to one of the following aluminum alloy designations: AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Optionally, the aluminum alloy as described herein can be a 5xxx series aluminum alloy according to one of the following aluminum alloy designations: AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Optionally, the aluminum alloy as described herein can be a 6xxx series aluminum alloy according to one of the following aluminum alloy designations: AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Optionally, the aluminum alloy as described herein can be a 7xxx series aluminum alloy according to one of the following aluminum alloy designations: AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Optionally, the aluminum alloy as described herein can be an 8xxx series aluminum alloy according to one of the following aluminum alloy designations: AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

The continuous coil can be prepared from an alloy of any suitable temper. In certain examples, the alloys can be used in F, O, HX1, HX2, HX3 HX4, HX5, HX6, HX7, HX8, HX9, T3, T4, T6, T7x (e.g., T73, T76, T79, or T77), or T8x tempers. The alloys can be produced by direct chill casting or semi-continuous casting, continuous casting (including, for example, by use of a twin belt caster, a twin roll caster, a block caster, or any other continuous caster), electromagnetic casting, hot top casting, or any other casting method.

While aluminum alloy products are described throughout the text, the methods and products apply to any metal. In some examples, the metal product is aluminum, an aluminum alloy, magnesium, a magnesium-based material, titanium, a titanium-based material, copper, a copper-based material, steel, a steel-based material, bronze, a bronze-based material, brass, a brass-based material, a composite, a sheet used in composites, or any other suitable metal or combination of materials. The metal product may include monolithic materials, as well as non-monolithic materials such as roll-bonded materials, clad materials, composite materials, or various other materials. In some examples, the metal product is a metal coil, a metal strip, a metal plate, a metal sheet, a metal billet, a metal ingot, or the like.

As described above, the surface of the continuous coil contains a thin anodized film layer. The anodized film layer includes a barrier layer and, optionally, a filament layer. The barrier layer is composed of aluminum oxide (e.g., nonporous aluminum oxide). The barrier layer can be up to about 25 nm in thickness. In some cases, the barrier layer can be from about 5 nm to about 25 nm, from about 10 nm to about 20 nm, or from about 12 nm to about 17 nm in thickness. For example, the barrier layer can be about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, or about 25 nm in thickness.

The filament layer is optionally present in the thin anodized film layer. Similar to the barrier layer, the filament layer is composed of aluminum oxide (e.g., nonporous aluminum oxide). The filament layer can be up to about 250 nm in thickness. In some cases, the filament layer can be from about 5 nm to about 225 nm, from about 10 nm to about 200 nm, from about 25 nm to about 150 nm, or from about 25 nm to about 75 nm in thickness. For example, the filament layer can be about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 105 nm, about 110 nm, about 115 nm, about 120 nm, about 125 nm, about 130 nm, about 135 nm, about 140 nm, about 145 nm, about 150 nm, about 155 nm, about 160 nm, about 165 nm, about 170 nm, about 175 nm, about 180 nm, about 185 nm, about 190 nm, about 195 nm, about 200 nm, about 205 nm, about 210 nm, about 215 nm, about 220 nm, about 225 nm, about 230 nm, about 235 nm, about 240 nm, about 245 nm, or about 250 nm in thickness.

The thin anodized film layer, including the barrier layer or the barrier layer and the filament layer, can range from about 15 nm to about 5 μm in thickness. In some cases, the thin anodized film layer is less than about 5 μm in thickness (e.g., less than about 4 μm, less than about 3 μm, less than about 2 μm, less than about 1 μm, less than about 500 nm, less than about 250 nm, less than about 100 nm, less than about 90 nm, less than about 80 nm, less than about 70 nm, less than about 60 nm, less than about 50 nm, less than about 40 nm, or less than about 30 nm). For example, the thin anodized film layer can be from about 25 nm to about 5 μm, from about 30 nm to about 4 μm, from about 40 nm to about 3 μm, from about 50 nm to about 2 μm, from about 60 nm to about 1 μm, from about 70 nm to about 750 nm, from about 80 nm to about 500 nm, or from about 90 nm to about 250 nm. In some examples, the thin anodized film layer can be about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, about 500 nm, about 525 nm, about 550 nm, about 575 nm, about 600 nm, about 625 nm, about 650 nm, about 675 nm, about 700 nm, about 725 nm, about 750 nm, about 775 nm, about 800 nm, about 825 nm, about 850 nm, about 875 nm, about 900 nm, about 925 nm, about 950 nm, about 975 nm, about 1 μm, about 1.1 μm, about 1.2 μm, about 1.3 μm, about 1.4 μm, about 1.5 μm, about 1.6 μm, about 1.7 μm, about 1.8 μm, about 1.9 μm, about 2 μm, about 2.1 μm, about 2.2 μm, about 2.3 μm, about 2.4 μm, about 2.5 μm, about 2.6 μm, about 2.7 μm, about 2.8 μm, about 2.9 μm, about 3 μm, about 3.1 μm, about 3.2 μm, about 3.3 μm, about 3.4 μm, about 3.5 μm, about 3.6 μm, about 3.7 μm, about 3.8 μm, about 3.9 μm, about 4 μm, about 4.1 μm, about 4.2 μm, about 4.3 μm, about 4.4 μm, about 4.5 μm, about 4.6 μm, about 4.7 μm, about 4.8 μm, about 4.9 μm, or about 5 μm in thickness.

### Methods of Preparing an Anodized Continuous Coil

Described herein are methods of making an anodized continuous coil. Anodizing a continuous coil as described herein includes anodizing a metal product after processing techniques used to provide the metal product in the form of a continuous coil, including casting (as described above), homogenizing, hot rolling, warm rolling, cold rolling, solution heat treating, annealing, aging (including natural aging and/or artificial aging), any suitable processing techniques, or any combination thereof. Accordingly, anodizing can be performed as a step subsequent to a processing step described above to provide the continuous coils. For example, systems to perform the anodizing step can be positioned downstream of a cold rolling mill, an annealing furnace, a continuous annealing and solution heat treating (CASH) line, or any suitable final processing equipment (i.e., the systems to perform the anodizing step can replace a metal coiler, or can be positioned between a penultimate metal processing equipment and a metal coiler). Thus, the metal can be processed into a metal product and can be anodized immediately after processing without coiling the metal product (e.g., to provide the continuous coil). Accordingly, when the systems to perform the anodizing step are placed in service in a metal processing line, parameters of the systems can depend on a line speed of the metal processing line, for example, line speeds selected and/or dictated by processes including the homogenization, the solution heat treating, and/or the annealing (i.e., temporally-dependent thermal processes). Thus, system parameters including applied power, electrolyte concentration, electrolyte temperature, and/or dwell time can be tailored according to the line speed of the metal processing line.

In some cases, the continuous coils described herein can be anodized after coiling. The continuous coils can be stored (e.g., to naturally age the continuous coils) or artificially aged before anodizing. Thus, the continuous coils (e.g., the stored continuous coils or the artificially aged continuous coils) can be uncoiled and fed into the systems described above for anodizing.

A continuous coil pretreatment process as described herein includes cleaning a surface of a continuous coil, etching the surface of the continuous coil with an acidic solution, anodizing the surface of the continuous coil to form a thin anodized film layer on the surface of the continuous coil, and rinsing the thin anodized film layer. The process described herein may be employed in a continuous coil process with coils spliced or joined together. Line speeds for the continuous coil process are variable and can be in the range of about 15 to about 100 meters per minute (mpm). For example, the line speed can be about 15 mpm, about 20 mpm, about 25 mpm, about 30 mpm, about 35 mpm, about 40 mpm, about 45 mpm, about 50 mpm, about 55 mpm, about 60 mpm, about 65 mpm, about 70 mpm, about 75 mpm, about 80 mpm, about 85 mpm, about 90 mpm, about 95 mpm, or about 100 mpm.

Cleaning and Preparing

The pretreatment process described herein can optionally include a step of cleaning one or more surfaces of a continuous coil. The entry cleaning removes residual oils, or loosely adhering oxides, from the coil surface. Optionally, the entry cleaning can be performed using a solvent (e.g., an aqueous or organic solvent). Optionally, one or more additives can be added to the solvent.

The pretreatment process includes a step of preparing a surface of the aluminum alloy continuous coil by electrolytically cleaning the surface of the continuous coil and/or etching the surface of the continuous coil. Optionally, the entry cleaning can be performed using an electrolytic cleaning step. The electrolytic cleaning is accomplished by contacting the aluminum alloy surface with an electrolyte and flowing an electric current through the electrolyte. Suitable electrolytes include, for example, aqueous solutions containing inorganic acids such as, but not limited to, sulfuric acid, nitric acid, phosphoric acid, or combinations of these. In some cases, suitable electrolytes include aqueous solutions of borates (e.g., sodium borate) and tartrates (e.g., sodium tartrate). Other exemplary electrolytes include aqueous solutions of sodium nitrate, sodium chloride, potassium nitrate, magnesium chloride, sodium acetate, copper sulfate, potassium chloride, magnesium nitrate, potassium nitrate, calcium chloride, lithium chloride, sodium carbonate, potassium carbonate, calcium carbonate, sodium bicarbonate, ammonium acetate, silver nitrate, ferric chloride, or any combination thereof, among others.

The electrolyte solution can be applied by immersing the alloy or a portion of an alloy (e.g., the alloy surface) in an electrolyte bath. The temperature of the electrolyte bath can be from about 80° C. to about 100° C. (e.g., about 80° C., about 85° C., about 90° C., about 95° C., or about 100° C.). The electrolytic cleaning can be performed for a suitable period of time to result in the desired level of cleaning. The period of time for performing the electrolytic cleaning varies based on the voltage being applied and can be adjusted by one of ordinary skill in the art.

The method may optionally, additionally, or alternatively include a step of etching one or more surfaces of the continuous coil. The surface of the continuous coil can be etched using an acid etch (i.e., an etching procedure that includes an acidic solution). The acid etch prepares the surface for subsequent anodization. Exemplary acids for performing the acid etch include sulfuric acid, hydrofluoric acid, nitric acid, phosphoric acid, and combinations of these.

Anodizing

The method described herein further includes a step of anodizing the surface of the continuous coil. The anodizing step results in the formation of a thin anodized film layer on the surface of the continuous coil. The anodizing is accomplished by contacting the aluminum alloy surface with an electrolyte and flowing an electric current through the electrolyte. Suitable electrolytes include, for example, aqueous solutions containing inorganic acids such as sulfuric acid, nitric acid, phosphoric acid, or combinations of these. In some cases, suitable electrolytes include aqueous solutions of borates (e.g., sodium borate) and tartrates (e.g., sodium tartrate). Other exemplary electrolytes include aqueous solutions of sodium nitrate, sodium chloride, potassium nitrate, magnesium chloride, sodium acetate, copper sulfate, potassium chloride, magnesium nitrate, potassium nitrate, calcium chloride, lithium chloride, sodium carbonate, potassium carbonate, calcium carbonate, sodium bicarbonate, ammonium acetate, silver nitrate, ferric chloride, or any combination thereof, among others.

A cathode is disposed parallel to the surface of the continuous coil such that the aluminum alloy surface is an anode. Current flow in the electrolyte releases oxygen ions that can migrate to the aluminum alloy surface and combine with aluminum on the aluminum alloy surface, thus forming alumina (Al₂O₃).

The electrolyte solution can be applied by immersing the alloy or a portion of an alloy (e.g., the alloy surface) in an electrolyte bath. The temperature of the electrolyte bath can be from about 20° C. to about 80° C. (e.g., from about 30° C. to about 70° C., from about 40° C. to about 60° C., from about 20° C. to about 50° C., or from about 40° C. to about 80° C.). For example, the temperature of the electrolyte bath can be about 20° C., about 30° C., about 40° C., about 50° C., about 60° C., about 70° C., or about 80° C. Optionally, the electrolyte solution can be circulated to ensure a fresh solution is continuously exposed to the alloy surfaces. The concentration of components in the electrolyte solution can be measured according to techniques as known to those of skill in the art, such as by a titration procedure for free and total acid or by inductively coupled plasma (ICP). For example, the aluminum content can be measured by ICP and controlled to be within a certain range.

The cathode can be mounted above the alloy, below the alloy, or above and below the alloy depending on desired anodization. The anodization can be performed for a suitable period of time, depending on desired thin anodized film layer thickness, to form the barrier layer or the barrier layer and the filament layer. The period of time for performing the anodization varies based on the voltage being applied and can be adjusted by one of ordinary skill in the art.

Rinsing and Drying the Thin Anodized Film Layer

After anodizing, the aluminum alloy continuous coil surface can be rinsed with a solvent to remove any residual electrolyte remaining after anodizing. Suitable solvents include, for example, aqueous solvents (e.g., deionized water), organic solvents, inorganic solvents, pH-specific solvents (e.g., solvents that do not react with the electrolyte), any suitable solvent, or any combination thereof. The rinse can be performed using sprays or by immersion. The solvent can be circulated to remove the residual electrolyte from the aluminum alloy continuous coil surface and to prevent its resettling on the surface. The temperature of the rinse solvent can be any suitable temperature.

Optionally, after the rinsing step, the surface of the continuous coil can be dried. The drying step removes any rinse water from the surface of the sheet or the coil. The drying step can be performed using, for example, an air dryer or an infrared dryer or any other suitable dryer. The drying step can be performed for a time period of up to five minutes. For example, the drying step can be performed for 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 60 seconds or more, 65 seconds or more, or 90 seconds or more, two minutes or more, three minutes or more, four minutes or more, or five minutes. A curing step or chemical reaction can optionally be performed.

The methods of preparing an anodized continuous coil described herein include various process parameters that must be tailored to provide a desired thin anodized film layer. In certain aspects, for example when the systems described herein are placed into a continuous coil processing line, the various process parameters that must be tailored to provide a desired thin anodized film layer depend on the line speed of the continuous coil processing line as described above. For example, variations in applied power can affect the properties of the thin anodized film layer, including dielectric breakdown, thickness, and uniformity (e.g., higher line speeds can require higher power application). In other examples, line speed can affect thin anodized film layer thickness, uniformity, and defect occurrence. Thus, creating a thin anodized film layer having properties can require extensive process parameter selection to arrive at a desired thin anodized film layer.

The systems and methods described herein provide the ability to provide metal products having a variety of surface characteristics without a need to batch process the metal products. For example, employing the systems and methods described herein to a metal product production line can provide the ability to clean the metal product, anodize the metal product, pretreat the metal product, or any combination thereof. Additionally, the systems and methods described herein can be employed in the production of a variety of metals as described above. In further examples, the systems and methods described herein can be applied to a metal product having any suitable thickness (e.g., any suitable gauge). Further, the systems and methods described herein provide a faster, more efficient, more cost-effective, and a more flexible process (e.g., a process able to provide a metal product or continuous coil having a variety of surface characteristics) for in-situ cleaning, in-situ anodizing, and/or in-situ pretreating the metal products.

### Properties of an Anodized Continuous Coil

The anodized continuous coils described herein can improve bond durability when a part provided using the anodized continuous coil (e.g., an automobile part, an aerospace part, or the like) is joined (e.g., bonded) to a second part provided using the anodized continuous coil or a part provided using a non-anodized metal part (e.g., a non-anodized aluminum alloy part, a non-anodized steel part, or the like). During bond durability testing described herein, bonds are created between two aluminum alloy products (e.g., two anodized aluminum alloy products as described herein or one anodized aluminum alloy product as described herein and one non-anodized aluminum alloy product), such as by an epoxy adhesive. Then, the bonded aluminum alloy products are subjected to strain and/or other conditions. For example, the bonded alloy products may be immersed in a salt solution, subject to humid conditions, or drying conditions. After a series of cycles in one or more conditions, the bonds between the aluminum alloys are evaluated for chemical and mechanical failure.

The anodized continuous coils described herein can improve bond durability by providing a porous surface that can absorb a bonding agent (e.g., an epoxy) and improve interfacial interactions between the bonding agent and the anodized continuous coil. Thus, the thin anodized film provides a greater surface area for the bonding agent to penetrate and secure the bond. Further, the anodized continuous coils provide aluminum alloy products that have a surface that promotes adhesion and/or resists corrosion without adding a solution-based pretreatment (e.g., an adhesion promoter solution of a corrosion inhibitor solution) in a downstream processing step. In certain examples, the thin anodized film is an aluminum alloy surface pretreatment. Additionally, the thin anodized film is a pretreatment that is resistant to the temperatures used in subsequent thermal treatments (e.g., artificial aging, solution heat treatment, hot forming, warm forming, annealing, paint baking, or the like). Thus, the thin anodized film and methods of providing the anodized continuous coils described herein provide an aluminum alloy amenable to surface treating before subsequent processing steps performed at elevated temperatures.

### Methods of Using

The continuous coils described herein can be used in forming products, including products for use in, among others, automotive, electronics, and transportation applications, such as commercial vehicle, aircraft, or railway applications, or any other suitable application. The continuous coils and methods described herein provide products with surface properties desired in various applications. The products described herein can have high strength, high deformability (elongation, stamping, shaping, formability, bendability, or hot formability), high strength, and high deformability. Employing a thin anodized film (TAF) as a surface pretreatment for a continuous coil provides a product that is deformable without damaging the pretreatment. For example, certain polymer based pretreatment films can break during the bending operations used to form an aluminum alloy product.

In some further aspects, employing a TAF as a pretreatment provides a pretreated aluminum alloy product that is thermally treatable without damaging the pretreatment. For example, a hot forming procedure can be applied to form an aluminum alloy product. In some examples, the hot forming can include heating the aluminum alloy product to temperatures of about 100° C. to about 600° C. at a heating rate of about 3° C./second to about 90° C./second, deforming the aluminum alloy product to form an aluminum alloy product, optionally repeating the deforming step and cooling the aluminum alloy product. Certain pretreatments cannot sustain such temperatures, damaging any pretreatment film. The continuous coils described herein, containing the thin anodized film layer, display an improved adhesion of coatings and corrosion resistance as compared to continuous coils that do not contain the thin anodized film.

In some examples, the continuous coils described herein can be used for chassis, cross-member, and intra-chassis components (encompassing, but not limited to, all components between the two C channels in a commercial vehicle chassis) to gain strength, serving as a full or partial replacement of high-strength steels. In certain examples, the alloys can be used in O, F, T4, T6, T7x, or T8x tempers. In certain aspects, the alloys and methods can be used to prepare motor vehicle body part products. For example, the disclosed alloys and methods can be used to prepare automobile body parts, such as bumpers, side beams, roof beams, cross beams, pillar reinforcements (e.g., A-pillars, B-pillars, and C-pillars), inner panels, side panels, floor panels, tunnels, structure panels, reinforcement panels, inner hoods, or trunk lid panels. The disclosed aluminum alloys and methods can also be used in aircraft or railway vehicle applications, to prepare, for example, external and internal panels.

The described alloys and methods can also be used to prepare housings for electronic devices, including mobile phones and tablet computers. For example, the alloys can be used to prepare housings for the outer casing of mobile phones (e.g., smart phones) and tablet bottom chassis, with or without anodizing. Exemplary consumer electronic products include mobile phones, audio devices, video devices, cameras, laptop computers, desktop computers, tablet computers, televisions, displays, household appliances, video playback and recording devices, and the like. Exemplary consumer electronic product parts include outer housings (e.g., facades) and inner pieces for the consumer electronic products.

The described alloys and methods can be used in any other desired application.

### Illustrations

Illustration 1 is an anodized continuous coil, comprising an aluminum alloy continuous coil, wherein a surface of the aluminum alloy continuous coil comprises a thin anodized film layer.

Illustration 2 is the anodized continuous coil of any preceding or subsequent illustration, wherein the thin anodized film layer comprises a barrier layer.

Illustration 3 is the anodized continuous coil of any preceding or subsequent illustration, wherein the barrier layer is up to about 25 nm in thickness.

Illustration 4 is the anodized continuous coil of any preceding or subsequent illustration, wherein the barrier layer comprises aluminum oxide.

Illustration 5 is the anodized continuous coil of any preceding or subsequent illustration, wherein the thin anodized film layer comprises a filament layer.

Illustration 6 is the anodized continuous coil of any preceding or subsequent illustration, wherein the filament layer is up to about 250 nm in thickness.

Illustration 7 is the anodized continuous coil of any preceding or subsequent illustration, wherein the filament layer comprises aluminum oxide.

Illustration 8 is the anodized continuous coil of any preceding or subsequent illustration, wherein the thin anodized film layer is less than about 5 μm in thickness.

Illustration 9 is the anodized continuous coil of any preceding or subsequent illustration, wherein the aluminum alloy continuous coil comprises a 7xxx series aluminum alloy. Illustration 10 is an aluminum alloy product prepared from the anodized continuous coil of any preceding or subsequent illustration.

Illustration 11 is the aluminum alloy product of any preceding or subsequent illustration, wherein the aluminum alloy product comprises an automobile body part.

Illustration 12 is a method of making an anodized continuous coil, comprising providing an aluminum alloy continuous coil, wherein the aluminum alloy continuous coil is processed in a metal processing line having a preselected line speed; preparing a surface of an aluminum alloy continuous coil and anodizing the surface of the aluminum alloy continuous coil in an electrolyte to form a thin anodized film layer, wherein anodizing parameters are tailored to the line speed of the metal processing line.

Illustration 13 is the method of any preceding or subsequent illustration, wherein the thin anodized film layer comprises an aluminum oxide layer.

Illustration 14 is the method of any preceding or subsequent illustration, wherein the thin anodized film layer is less than about 5 μm in thickness.

Illustration 15 is the method of any preceding or subsequent illustration, wherein the electrolyte comprises one or more of sulfuric acid, nitric acid, and phosphoric acid.

Illustration 16 is the method of any preceding or subsequent illustration, wherein the preparing step comprises one or both of etching the surface of the aluminum alloy continuous coil with an acidic solution and electrolytically cleaning the surface of the aluminum alloy continuous coil.

Illustration 17 is the method of any preceding or subsequent illustration, further comprising applying a cleaner to the surface of the aluminum alloy continuous coil prior to the preparing step.

Illustration 18 is the method of any preceding or subsequent illustration, further comprising rinsing the thin anodized film layer after the anodizing step.

Illustration 19 is the method of any preceding or subsequent illustration, further comprising drying the surface of the aluminum alloy continuous coil.

Illustration 20 is the method of any preceding or subsequent illustration, wherein the aluminum alloy continuous coil comprises a 7xxx series aluminum alloy.

Illustration 21 is the method of any preceding illustration, wherein the acidic solution in the etching step comprises one or more of sulfuric acid, nitric acid, and phosphoric acid.

The following examples will serve to further illustrate the present invention without, however, constituting any limitation thereof. On the contrary, it is to be clearly understood that resort may be had to various embodiments, modifications, and equivalents thereof which, after reading the description herein, may suggest themselves to those skilled in the art without departing from the spirit of the invention.

### EXAMPLES

### Example 1: Bond Durability Testing

Anodized continuous coils were prepared for bond durability testing according to methods described herein, including an optional artificial aging, etching, electrolytic cleaning, and anodizing. In certain examples where artificial aging was not performed before etching, the samples were subjected to artificial aging after anodizing. Processing parameters are summarized in Table 1 below:

TABLE 1

| | | | | | | | TEM | |
|---|---|---|---|---|---|---|---|---|
| | | | Electrolytic | | | | analysis | |
| | | | Cleaning | | Anodizing | | Bar- | |
| | | Etch | | Volt- | | Volt- | rier | |
| | Tem- | Temp. | Time | age | Time | age | layer | Fil. |
| ID | per | (° C.) | (sec) | (VAC) | (sec) | (VDC) | (nm) | (nm) |
| TAF-A | T6 | 85 | 10 | 24 | 10 | 24 | 12 | 10 |
| TAF-B | T6 | 85 | 10 | 24 | 20 | 24 | 7 | 30 |
| TAF-C | T6 | 85 | 10 | 24 | 30 | 24 | 12 | 100 |
| TAF-D | T6 | 85 | 10 | 24 | 40 | 24 | 9 | 100 |
| TAF-E | T6 | 55 | 10 | 12 | 240 | 12 | 10 | 240 |
| TAF-F | T6 | 55 | 10 | 12 | 120 | 12 | 8 | 80 |
| TAF-G | F | 55 | 10 | 12 | 120 | 12 | 10 | 120 |
| TAF-H | F | 85 | 10 | 24 | 20 | 24 | 0 | 55 |
| TAF-I | F | 55 | 10 | 12 | 120 | 12 | 20 | 190 |

As shown in Table 1, Samples TAF-A, TAF-B, TAF-C, TAF-D, TAF-E, and TAF-F were subjected to the optional artificial aging step to achieve a T6 temper before the etching step. Samples TAF-G, TAF-H, and TAF-I were provided in an F temper and were artificially aged to T6 temper prior to bonding. All samples were subjected to etching in 0.1 M phosphoric acid. Etching temperatures are shown in Table 1 above. After the etching step, all samples were subjected to the electrolytic cleaning step described above for 10 seconds at various voltages. After the electrolytic cleaning step, all samples were subjected to the anodizing step in 0.1 M phosphoric acid, performed at various times and voltages.

After the anodizing step, Samples TAF-A, TAF-B, TAF-C, TAF-D, TAF-E, and TAF-F were subjected to transmission electron microscope (TEM) analysis to determine the thickness of the barrier layer and the filament layer (referred to as “Fil.” In Table 1). Samples TAF-B, TAF-D, and TAF-F were subjected to the bond durability testing. After the anodizing step, Samples TAF-G, TAF-H, and TAF-I were subjected to the artificial aging step to provide Samples TAF-G, TAF-H, and TAF-I in a T6 temper. After the artificial aging step, Samples TAF-G, TAF-H, and TAF-I were subjected to transmission electron microscope (TEM) analysis to determine the thickness of the barrier layer and the filament layer (referred to as “Fil.” In Table 1). Samples TAF-H and TAF-I were subjected to the bond durability testing. Bond durability test results are shown in Table 2 below:

TABLE 2

| | Bond Durability test performed at 90% Relative Humidity | | | | | |
|---|---|---|---|---|---|---|
| | (Cycles to Failure) | | | | | |
| Sample ID | Bond 1 | Bond 2 | Bond 3 | Bond 4 | Bond 5 | Bond 6 |
| TAF-B | 21 | 21 | 16 | 13 | 15 | 21 |
| TAF-D | 10 | 8 | 9 | 10 | 10 | 6 |
| TAF-F | 25 | 25 | 24 | 25 | 23 | 15 |
| TAF-H | 60 | 60 | 60 | 60 | 60 | 60 |
| TAF-I* | 21 | 21 | 21 | 21 | 21 | 21 |

*Sample TAF-I successfully completed 21 test cycles without failure

As shown in Table 2, the samples provided and anodized in the F temper exhibited superior bond durability when compared to the samples provided in the T6 temper before etching and anodizing. Additionally, samples provided in the F temper and subjected to the methods described herein can be anodized before subsequent thermal treatment because the thin anodized film is resistant to the temperatures used in subsequent thermal treatments (e.g., artificial aging, solution heat treatment, hot forming, warm forming, annealing, paint baking, or the like). Thus, the thin anodized film and methods of providing the anodized continuous coils described herein provide an aluminum alloy amenable to surface treating before subsequent processing steps performed at elevated temperatures. Conversely, pretreatments derived from solution-based organic and/or inorganic materials are susceptible to deterioration and degradation at elevated temperatures.

All patents, publications, and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the present invention as defined in the following claims.

What is claimed is:

1. An anodized continuous coil, comprising:
an aluminum alloy continuous coil, wherein a surface of the aluminum alloy continuous coil comprises a thin anodized film layer.

2. The anodized continuous coil of claim 1, wherein the thin anodized film layer comprises a barrier layer.

3. The anodized continuous coil of claim 2, wherein the barrier layer is up to about 25 nm in thickness.

4. The anodized continuous coil of claim 2, wherein the barrier layer comprises aluminum oxide.

5. The anodized continuous coil of claim 1, wherein the thin anodized film layer comprises a filament layer.

6. The anodized continuous coil of claim 5, wherein the filament layer is up to about 250 nm in thickness.

7. The anodized continuous coil of claim 5, wherein the filament layer comprises aluminum oxide.

8. The anodized continuous coil of claim 1, wherein the thin anodized film layer is less than about 5 μm in thickness.

9. The anodized continuous coil of claim 1, wherein the aluminum alloy continuous coil comprises a 7xxx series aluminum alloy.

10. An aluminum alloy product prepared from the anodized continuous coil of claim 1.

11. The aluminum alloy product of claim 10, wherein the aluminum alloy product comprises an automobile body part.

12. A method of making an anodized continuous coil, comprising:
providing an aluminum alloy continuous coil, wherein the aluminum alloy continuous coil is processed in a metal processing line having a preselected line speed;
preparing a surface of the aluminum alloy continuous coil; and
anodizing the surface of the aluminum alloy continuous coil in an electrolyte to form a thin anodized film layer, wherein anodizing parameters are tailored to the line speed of the metal processing line.

13. The method of claim 12, wherein the thin anodized film layer comprises an aluminum oxide layer.

14. The method of claim 12, wherein the thin anodized film layer is less than about 5 μm in thickness.

15. The method of claim 12, wherein the electrolyte comprises one or more of sulfuric acid, nitric acid, and phosphoric acid.

16. The method of claim 12, wherein the preparing step comprises one or both of etching the surface of the aluminum alloy continuous coil with an acidic solution and electrolytically cleaning the surface of the aluminum alloy continuous coil.

17. The method of claim 12, further comprising applying a cleaner to the surface of the aluminum alloy continuous coil prior to the preparing step.

18. The method of claim 12, further comprising rinsing the thin anodized film layer after the anodizing step.

19. The method of claim 12, further comprising drying the surface of the aluminum alloy continuous coil.

20. The method of claim 12, wherein the aluminum alloy continuous coil comprises a 7xxx series aluminum alloy.
